(19) United States
(12) Patent Application Publication
(10) Pub. No.: US 2010/0141900 A1
(43) Pub. Date: Jun. 10, 2010

(54) LIGHT SOURCE DEVICE AND PROJECTOR

(75) Inventors: Toshimasa Kanbara, Kishiwada-shi (JP); Taichi Yoshimura, Osaka-shi (JP); Yasuyuki Hirouchi, Daito-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/630,339

(22) Filed: Dec. 3, 2009

(30) Foreign Application Priority Data
Dec. 5, 2008 (JP) 2008-310943

(51) Int. Cl. G03B 21/16; F21V 29/00

(52) U.S. Cl. 353/61; 362/373

(57) ABSTRACT

A lamp unit configuring a light source device capable of efficiently cooling a light source by a simple structure includes a light source and a plurality of air outlets for discharging the cooling air for cooling the light source. The plurality of air outlets include a first air outlet for discharging the cooling air in a first direction and a second air outlet for discharging the cooling air in a second direction. The cooling air discharged through the first air outlet is different in airflow rate from the cooling air discharged through the second air outlet, and the first direction is different from the second direction when viewed in the direction of the optical axis of the light source.

### BACKGROUND OF THE INVENTION

1. Field of the Invention

The present invention relates to a light source device and a projector, and more particularly to a light source device allowing efficient cooling and a projector provided with the light source device.

2. Description of the Background Art

In recent years, an apparatus such as a projector including a light source device as a component has been developed to achieve higher performance, which requires the light source device to produce a high intensity of light. For the purpose of satisfying this requirement, there is a tendency to provide the light source device with a light source producing a large amount of light. Since this light source producing a large amount of light may often generate a great amount of heat, efficient cooling is required.

Accordingly, for example, a light source device having an inflow passage and an outflow passage for the cooling fluid arranged approximately in parallel with the surface of a light emitting element base to which a light emitting element is attached has been proposed, by which a light source device with an improved cooling effect can be provided (for example, see Japanese Patent Laying-Open No. 2005-79150 (Patent Document 1)).

However, the structure disclosed in the above-described Patent Document 1 requires the inflow and outflow passages to be arranged approximately in parallel with the light emitting element, which may result in a complicated structure.

### SUMMARY OF THE INVENTION

Thus, an object of the present invention is to provide a light source device capable of efficiently cooling a light source by a simplified structure, and a projector provided with the light source device.

A light source device according to the present invention includes a light source and a plurality of air outlets for discharging cooling air for cooling the light source. The plurality of air outlets include a first air outlet for discharging the cooling air in a first direction and a second air outlet for discharging the cooling air in a second direction. The cooling air discharged through the first air outlet is different in airflow rate from the cooling air discharged through the second air outlet, and the first direction is different from the second direction when viewed in a direction of an optical axis of the light source.

The present inventors have made an earnest study on the direction and airflow rate of the cooling air which allow efficient cooling of the light source. As a result of the study, the inventors have found that at least two air outlets are arranged to cause each cooling air to be discharged in different directions and to cause a difference between the airflow rates of each cooling air, with the result that the cooling air is convected to provide a uniform flow of the cooling air around the light source, which allows the light source to be efficiently cooled. The light source device of the present invention includes at least two air outlets from which each cooling air is discharged in different directions when viewed in the direction of the optical axis of the light source. In addition, the airflow rate of the cooling air is different between these two air outlets from which each cooling air is discharged. Therefore, the light source device of the present invention allows the light source to be efficiently cooled.

Preferably, the above-described light source device further includes an airflow rate adjustment unit capable of separately adjusting the airflow rate of the cooling air discharged through the first air outlet and the airflow rate of the cooling air discharged through the second air outlet.

The light source provided in the light source device may be configured to have a temperature range to be maintained that varies depending on the direction in which the light source device is installed. More specifically, for example, the temperature which should be maintained may be different between the upper region and the lower region of the light source with respect to the vertical direction. In addition, an apparatus such as a projector may be installed in several directions depending on its use. Accordingly, with respect to the vertical direction, the upper region of the light source installed in one direction may be located in a position corresponding to the lower region of the light source installed in another direction. In this case, it is preferable to change the cooling condition of the light source in accordance with the installation direction.

Thus, as the above-described airflow rate adjustment unit is provided, the cooling condition of the light source can be changed in accordance with the installation direction. Consequently, a light source device suitable for the apparatus capable of freely selecting the installation direction (the apparatus accommodating any installation direction through 360 degrees) can be provided.

In the above-described light source device, it is preferable that the first direction is different from a direction extending from the first air outlet to a center of the light source when viewed in the direction of the optical axis of the light source. Furthermore, the second direction is different from a direction extending from the second air outlet to the center of the light source when viewed in the direction of the optical axis of the light source.

Consequently, the cooling air can readily be convected around the light source, to allow the light source to be much more efficiently cooled.

In the above-described light source device, it is preferable that the first air outlet and the second air outlet are arranged to face each other with the light source interposed therebetween. This facilitates the cooling air to be smoothly convected through the entire area around the light source, to allow the light source to be further efficiently cooled.

In the above-described light source device, it is preferable that a first imaginary line extending from the first air outlet in the first direction is prevented from intersecting with a second imaginary line extending from the second air outlet in the second direction.

Consequently, the cooling air can readily be convected around the light source, to allow the light source to be much more efficiently cooled.

A projector according to the present invention includes the light source device of the present invention as described above. The projector of the present invention is provided with the light source device capable of efficiently cooling the light source, which allows an increase in the lifetime of the light source.

As apparent from the above description, according to the light source device and the projector of the present invention, a light source device capable of efficiently cooling a light source and a projector provided with the light source device can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a structure of a projector according to an embodiment of the present invention.

FIG. 2 is a schematic perspective view of a structure of a lamp unit included in the projector in FIG. 1.

FIG. 3 is a schematic plan view of the lamp unit as seen from the front thereof.

FIG. 4 is a schematic cross-sectional view taken along a line IV-IV in FIG. 3.

### DESCRIPTION OF THE PREFERRED EMBODIMENTS

The embodiments of the present invention will be hereinafter described with reference to the accompanying drawings, in which the same or corresponding components are designated by the same reference characters, and description thereof will not be repeated.

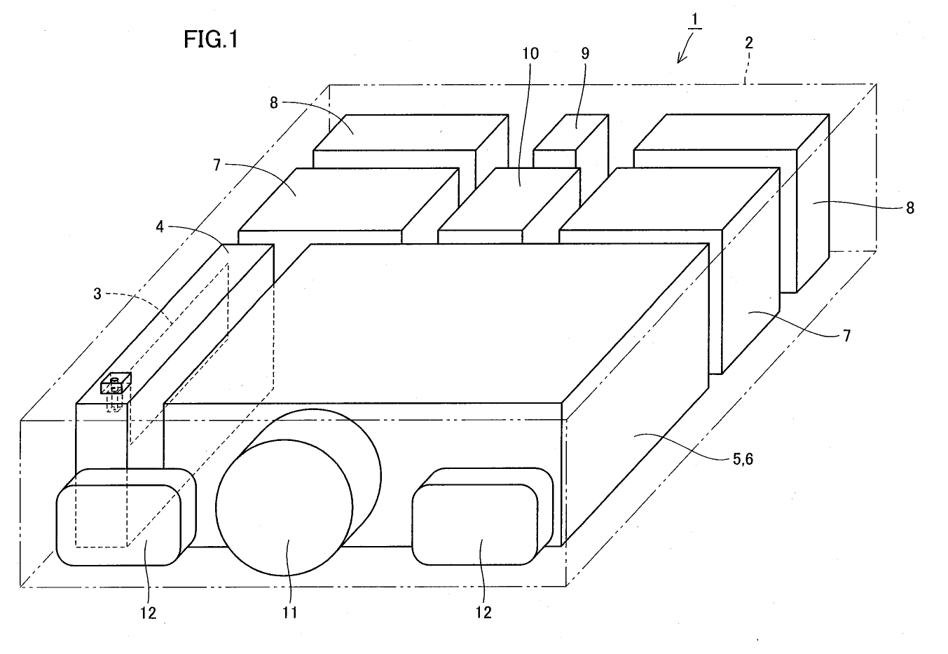

Referring to FIG. 1, a projector 1 according to the present embodiment has a casing 2 which includes therein a projection lens 11 for projecting an image; a pair of speakers 12 for audio output which are arranged to have projection lens 11 interposed therebetween; an optical system unit 5 disposed behind projection lens 11 for generating image light; a control circuit board unit 6 disposed behind projection lens 11 for controlling the operation of projector 1; and a pair of lamp units 7 disposed behind optical system unit 5 and control circuit board unit 6 for supplying light to optical system unit 5. During the operation of projector 1, only one of the pair of lamp units 7 is operated and the other serves as a spare lamp unit. Consequently, even when the light source placed in one of lamp units 7 suffers damage and the like during the operation of projector 1, the other lamp unit 7 serving as a spare is used to allow minimization of the time during which the operation of projector 1 is interrupted.

Furthermore, casing 2 of projector 1 includes therein an air intake member 4 having a filter 3 for introducing the outside air into casing 2; a pair of air exhaust fans 8 disposed behind the pair of lamp units 7, respectively, for discharging the air inside casing 2 to outside; a duct 10 disposed between the pair of lamp units 7 for guiding the cooling air to be supplied to each lamp unit 7; and an air supply fan 9 disposed behind duct 10 for supplying the cooling air through duct 10 to each lamp unit 7.

The cooling operation of projector 1 will then be described. Referring to FIG. 1, when air exhaust fan 8 is first operated, the pressure within casing 2 becomes negative relative to the pressure outside casing 2. Accordingly, the air is introduced from outside through filter 3 to air intake member 4 to flow into casing 2. This air serves to cool optical system unit 5 and control circuit board unit 6, and then flows toward the rear. A part of the air used to cool optical system unit 5 and control circuit board unit 6 is introduced by air supply fan 9 through duct 10 into lamp unit 7 for cooling the inside of lamp unit 7. Furthermore, another part of the air used to cool optical system unit 5 and control circuit board unit 6 cools the outside of lamp unit 7. The air used to cool lamp unit 7 is discharged by air exhaust fan 8 to the outside of casing 2. As described above, each component disposed within casing 2 is cooled. The above-described lamp unit 7 forming a light source device provided in projector 1 is configured in the same manner as that in an embodiment according to the present invention described below, which allows efficient cooling.

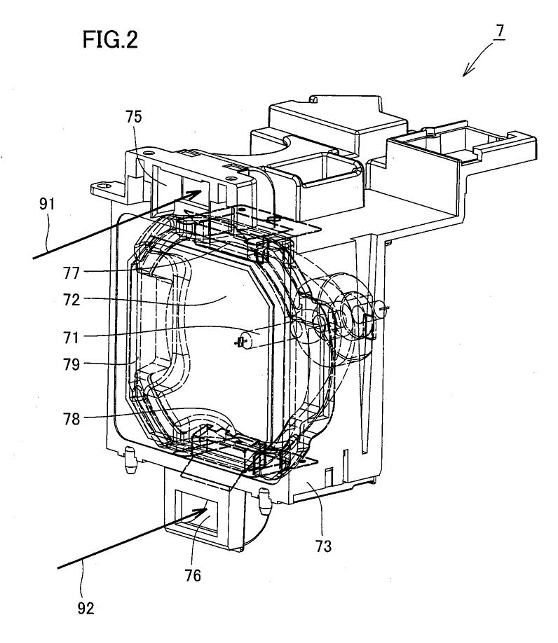

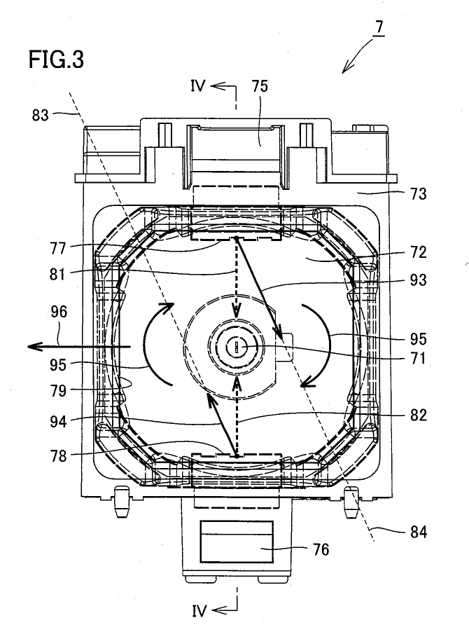

Referring to FIGS. 2-4, lamp unit 7 configuring the light source device according to the present embodiment includes a light source 71, a reflector 72 disposed so as to surround a valve 71A of light source 71, a frame 73 supporting reflector 72, and a cover 74 disposed so as to close the opening of reflector 72. Furthermore, frame 73 is provided with a first air inlet 75 and a second air inlet 76 for introducing the air (cooling air) into lamp unit 7. Lamp unit 7 is attached to projector 1 such that first air inlet 75 and second air inlet 76 face air supply fan 9 (see FIG. 1). Furthermore, a first air outlet 77 and a second air outlet 78 are provided between reflector 72 and frame 73. First air outlet 77 is an opening which is connected to first air inlet 75 for discharging, into lamp unit 7, the cooling air introduced through first air inlet 75. Second air outlet 78 is an opening which is connected to second air inlet 76 for discharging, into lamp unit 7, the cooling air introduced through second air inlet 76. Referring to FIG. 3, first air outlet 77 is configured to discharge the cooling air in a first direction 93. Second air outlet 78 is configured to discharge the cooling air in a second direction 94. As shown in FIG. 3, first direction 93 and second direction 94 are different from each other when viewed in the direction of the optical axis of light source 71. Furthermore, the cooling air discharged through first air outlet 77 is different in airflow rate from the cooling air discharged through second air outlet 78.

The flow of the cooling air in lamp unit 7 will then be described. Referring to FIG. 1, the cooling air supplied by air supply fan 9 through duct 10 to lamp unit 7 is sent in the direction along arrows 91 and 92 as shown in FIG. 2, and supplied through first air inlet 75 and second air inlet 76 into lamp unit 7. As shown in FIG. 3, this cooling air is discharged through first air outlet 77 in first direction 93 and also discharged through second air outlet 78 in second direction 94. In this case, the cooling air discharged through first air outlet 77 is different in airflow rate from the cooling air discharged through second air outlet 78, as described above. Accordingly, the cooling air introduced into lamp unit 7 is convected in the direction along an arrow 95 and flows around light source 71 to form a uniform swirling flow, which allows light source 71 to be efficiently cooled. In order to cause a difference in airflow rate between the cooling air discharged from first air outlet 77 and the cooling air discharged from second air outlet 78 as described above, for example, referring FIG. 1, air supply fan 9 may be configured to include the first fan for supplying the cooling air to first air inlet 75 and the second fan for supplying the cooling air to second air inlet 76. In addition, the rotation speed of the first fan and the rotation speed of the second fan are set to be different from each other, with the result that the conditions of the airflow rate of the cooling air as described above can be achieved.

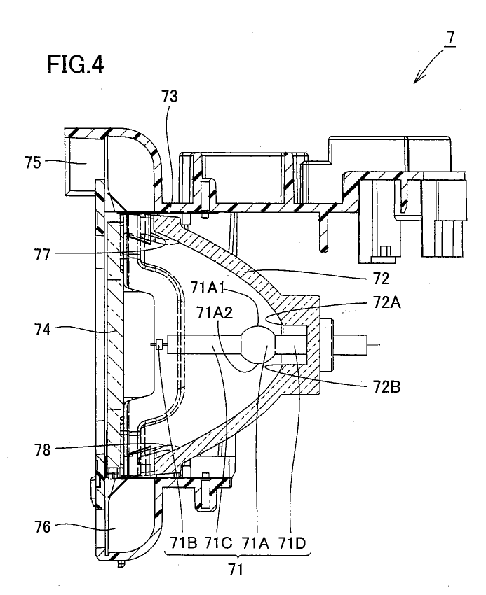

Referring to FIG. 4, within lamp unit 7 according to the present embodiment, each component such as a valve 71A, a flange 71B, a sealing portion on the flange side 71C, and a sealing portion on the hole side 71D of light source 71, and a hole upper portion 72A and a hole lower portion 72B of reflector 72 should be maintained at a predetermined temperature. Furthermore, for example, the temperature range to be maintained is different between an upper portion 71A1 and a lower portion 71A2 which are located on the upper side and the lower side, respectively, of valve 71A with respect to the vertical direction. However, upper portion 71A1 and lower portion 71A2 of valve 71A vary in position depending on the direction in which projector 1 is installed. Thus, in the present embodiment, since a uniform swirling flow is generated around light source 71 by the cooling air discharged through first air outlet 77 and second air outlet 78, the temperature in each component of light source 71 can be maintained at a suitable level irrespective of the installation direction of projector 1.

Furthermore, in the present embodiment, as shown in FIG. 3, it is preferable that, when viewed in the direction of the optical axis of light source 71, first direction 93 is different from a direction 81 extending from first air outlet 77 to the center of light source 71, and second direction 94 is different from a direction 82 extending from second air outlet 78 to the center of light source 71. This facilitates the cooling air to be convected around light source 71 along arrow 95, and therefore, light source 71 can be further efficiently cooled.

Furthermore, in the present embodiment, as shown in FIG. 3, it is preferable that first air outlet 77 and second air outlet 78 are arranged facing each other so as to have light source 71 interposed therebetween. This facilitates the cooling air to be smoothly convected through the entire area around light source 71, to allow light source 71 to be further efficiently cooled.

Furthermore, in the present embodiment, it is preferable that a first imaginary line 84 extending from first air outlet 77 in first direction 93 and a second imaginary line 83 extending from second air outlet 78 in second direction 94 are set so as not to intersect with each other. Consequently, the cooling air can readily be convected around light source 71, which allows light source 71 to be much more efficiently cooled. It is preferable that first imaginary line 84 and second imaginary line 83 are in parallel with each other in order to achieve further efficient cooling of light source 71.

While various types of light emitting devices may be employed as a light source according to the present invention, it is particularly effective to apply the present invention in the case where an ultrahigh pressure mercury lamp, a xenon lamp, a metal halide lamp, or the like is employed which requires a relatively strict temperature control as compared to another light emitting device.

Furthermore, although the case where the light source device includes two air outlets has been described in the above embodiments, the light source device of the present invention is not limited thereto, and may include three or more air outlets. In this case, two of three or more air outlets may be configured in accordance with the above-described present invention.

Furthermore, although the case where the light source device of the present invention is installed in the projector has been described in the above embodiments, the light source device of the present invention may be installed and used in another type of apparatus.

The light source device and the projector according to the present invention may be particularly advantageously applied for a light source device requiring efficient cooling and a projector provided with this light source device.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A light source device comprising:
a light source; and
a plurality of air outlets for discharging cooling air for cooling said light source,
said plurality of air outlets including a first air outlet for discharging said cooling air in a first direction and a second air outlet for discharging said cooling air in a second direction, and
said cooling air discharged through said first air outlet being different in airflow rate from said cooling air discharged through said second air outlet, and said first direction being different from said second direction when viewed in a direction of an optical axis of said light source.

2. The light source device according to claim 1, further comprising an airflow rate adjustment unit capable of separately adjusting the airflow rate of said cooling air discharged through said first air outlet and the airflow rate of said cooling air discharged through said second air outlet.

3. The light source device according to claim 1, wherein
said first direction is different from a direction extending from said first air outlet to a center of said light source when viewed in the direction of the optical axis of said light source, and
said second direction is different from a direction extending from said second air outlet to the center of said light source when viewed in the direction of the optical axis of said light source.

4. The light source device according to claim 1, wherein said first air outlet and said second air outlet are arranged to face each other with said light source interposed therebetween.

5. The light source device according to claim 4, wherein a first imaginary line extending from said first air outlet in said first direction is prevented from intersecting with a second imaginary line extending from said second air outlet in said second direction.

6. A projector comprising the light source device according to claim 1.
